(19) United States
(12) Patent Application Publication
(10) Pub. No.: US 2024/0171371 A1
(43) Pub. Date: May 23, 2024

(54) HOMOMORPHIC ENCRYPTION ENCODE/ENCRYPT AND DECRYPT/DECODE DEVICE

(71) Applicant: Intel Corporation, Santa Clara, CA (US)

(72) Inventors: Jeremy Bottleson, North Plains, OR (US); Kylan Race, Austin, TX (US); Ernesto Zamora Ramos, Folsom, CA (US); Fillipe Dias Moreira De Souza, Folsom, CA (US); Akshaya Jagannadharao, Columbia, SC (US); Brad Smith, Vancouver, WA (US)

(73) Assignee: Intel Corporation, Santa Clara, CA (US)

(21) Appl. No.: 17/993,561

(22) Filed: Nov. 23, 2022

(51) Int. Cl. H04L 9/00; H04L 9/06

(52) U.S. Cl. CPC H04L 9/008; H04L 9/0618

(57) ABSTRACT

Homomorphic encryption (HE) acceleration circuitry includes encode circuitry to encode cleartext data into plaintext data, encrypt circuitry to encrypt the plaintext data into HE ciphertext data according to an HE process, decrypt circuitry to decrypt the HE ciphertext data into the plaintext data according to the HE process, and decode circuitry to decode the plaintext data into the cleartext data.

### FIELD

Embodiments relate generally to homomorphic encryption in a computing system, and more particularly, to implementing homomorphic encryption in accelerator circuitry for use in fixed power budget computing systems.

### BACKGROUND

Homomorphic encryption (HE) allows computations to be performed on encrypted data without revealing input and output information to service providers or other computing systems. Homomorphic encryption is a form of encryption that permits users to perform computations on the encrypted data without first decrypting it. These resulting computations are left in an encrypted form which, when decrypted, result in an identical output to that produced had the operations been performed on the unencrypted data. Homomorphic encryption can be used for privacy-preserving outsourced storage and computation. This allows data to be encrypted and outsourced to commercial cloud environments for processing, all while encrypted.

Current HE operations are typically performed in software by executing instructions on a traditional general purpose computing system (e.g., a computer server, a personal computer, etc.). However, some desired locations for implementations of HE do not provide the computing resources necessary to perform HE operations. Furthermore, performing HE operations by executing software on a traditional general purpose computing system is often too slow and power inefficient for many applications and scenarios.

### BRIEF DESCRIPTION OF THE DRAWINGS

So that the manner in which the above recited features of the present embodiments can be understood in detail, a more particular description of the embodiments, briefly summarized above, may be had by reference to embodiments, some of which are illustrated in the appended drawings. It is to be noted, however, that the appended drawings illustrate only typical embodiments and are therefore not to be considered limiting of its scope. The figures are not to scale. In general, the same reference numbers will be used throughout the drawings and accompanying written description to refer to the same or like parts.

FIG. 1 illustrates a HE system according to an implementation.

FIG. 2 illustrates HE accelerator circuitry according to an implementation.

FIG. 3 is a flow diagram of HE accelerator processing according to an implementation.

FIG. 4 illustrates HE accelerator circuitry according to an implementation.

FIG. 5 illustrates ring learning with errors (RLWE) acceleration circuitry and RLWE working memory of HE circuitry according to an implementation.

FIG. 6 is a schematic diagram of an illustrative electronic computing device including HE accelerator circuitry to perform HE processing according to an implementation.

### DETAILED DESCRIPTION

Implementations of the disclosure provide homomorphic encryption (HE) accelerator circuitry to efficiently perform encoding, decoding, encrypting and decrypting operations according to a HE process. HE computing has many desirable privacy preserving applications but comes with significant computational and power requirements. In an implementation, the HE accelerator circuitry is embodied in an intellectual property (IP) block of an application specific integrated circuit (ASIC) for high speed, low latency and low power characteristics. In an implementation, the ASIC may be as a system on a chip (SoC) design in fixed power, battery operated client devices such as Internet of Things (IoT) sensor devices, monitoring devices, smartphones, tablet computers, augmented reality (AR)/virtual reality (VR) headsets, etc. The IP block implementation described herein significantly lowers the power and latency of HE solutions on such client devices. In an implementation, the HE accelerator circuitry performs a selected HE process, such as ring learning with errors (RLWE) encryption and decryption processing.

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and/or other changes may be made without departing from the scope of the subject matter of this disclosure. The following detailed description is, therefore, provided to describe example implementations and not to be taken as limiting on the scope of the subject matter described in this disclosure. Certain features from different aspects of the following description may be combined to form yet new aspects of the subject matter discussed below.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real-world imperfections.

As used herein, “processor”, “processor circuitry”, and “accelerator circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of such circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, IP blocks, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

As used herein, a computing system can be, for example, a server, a disaggregated server, a personal computer, a workstation, a self-learning machine (e.g., a neural network), a mobile device (e.g., a cell phone, a smart phone, a tablet (such as an iPad™)), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, an IoT device, a sensor device, a monitoring device, a drone, or any other type of computing device.

As used herein, a component of a computing system includes any integrated circuit (IC) providing one or more capabilities of a product such as a processor and/or an accelerator, a memory, an interconnect, wired communication circuitry, wireless communication circuitry, a system on a chip (SoC), accelerator, integrated graphics circuitry, on-die memory (e.g., high bandwidth memory (HBM)), use case specific on-die accelerators, or any other circuitry in a computing system. In some instances, a component may be referred to as an IP block. A component may include firmware, such as a basic input/output system (BIOS).

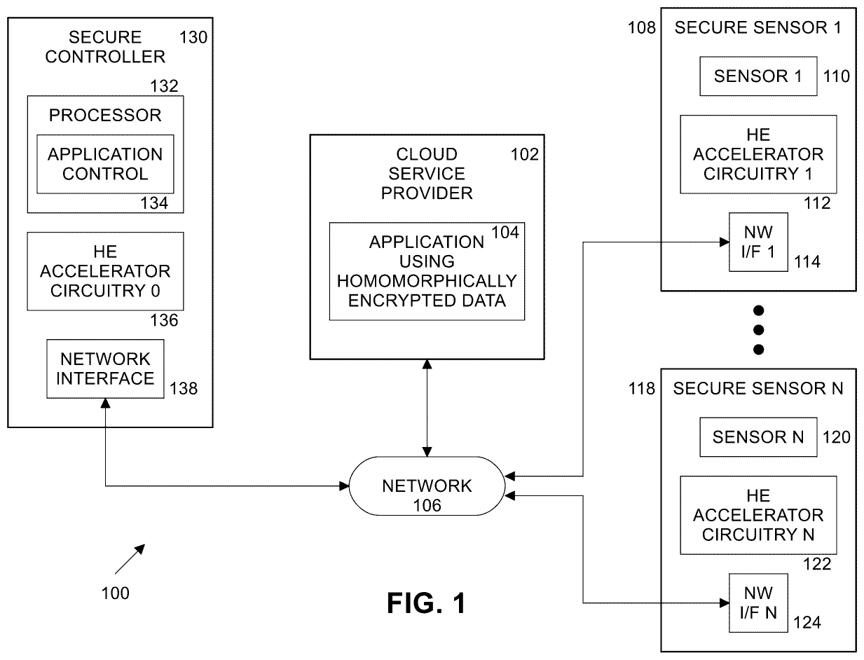

FIG. 1 illustrates a HE system 100 according to an implementation. A cloud service provider (CSP) 102 may provide applications and/or services to users, including an application using homomorphically encrypted (HE) data 104. For example, application using HE data 104 may monitor secure sensors, provide encrypted voice calling, provide a secure virtual assistant, provide secure telemetry analysis and control of data, provide a secure scanner, provide services to read and/or update a HE protected machine learning model, provide secure financial information, perform protected searches, etc. For example, a use case for application using HE data 104 may be remote management of sensors monitoring a sensitive installation, such as a nuclear power plant. In an implementation, application using HE data 104 may securely perform any useful computations on HE data collected over time. The CSP 102 has no knowledge of the function of the application using HE data 104 nor of the HE input data or HE output data associated with the application using HE data 104. Generally, the CSP may not be trusted by other computing systems and client devices.

In the technology described herein, data is encrypted by HE accelerator circuitry using a HE process local to a client device. HE accelerator circuitry uses a public key for encrypting data before sending the HE encrypted data over a network and a private key for decrypting received HE encrypted data. Only the client device has access to the private keys necessary to decrypt this data. The encrypted input data is sent from a source client device over a network 106 to one or more CSP 102 servers where application using HE data 104 is run on one or more of those servers using the client device's encrypted data as HE input data. In HE, the output data of computations is also encrypted with the client device's keys, ensuring the client device's data is inaccessible by the untrusted CSP throughout the operation of the application using HE data 104. The encrypted results (e.g., HE output data) are sent back to a client device (which may be a different client device than the one that sent the HE data to the CSP) where the HE data is decrypted locally and utilized in a local application on the client device. The encrypted data is also protected while in transit over the insecure network 106 (such as the Internet, an intranet, a local area network (LAN), a wide area network (WAN), a cellular telephone network, etc.).

In an example, a plurality of secure sensors such as secure sensor 1 108 . . . secure sensor N 118 (where N is a natural number), obtain data (from a sensor, for example), encrypt the data with an HE process by HE accelerator circuitry in the secure sensor to form HE input data, and send the HE input data to the application using HE data 104 running in the CSP 102. Each secure sensor includes at least one sensor (or other data gathering device), HE accelerator circuitry, and a network interface (NW I/F). For example, secure sensor 1 108 includes sensor 1 110, HE accelerator circuitry 1 112, and NW I/F 1 114, . . . secure sensor N 118 includes sensor N 120, HE accelerator circuitry N 122, and NW I/F N 124. Secure sensors may include other circuitry and/or components as needed, which is omitted for clarity in FIG. 1.

In other examples, other domain-specific client devices (e.g., smartphones, AR/VR headsets, other IoT devices, monitoring devices, tablet computers, drones, portable computing systems, vehicles, etc.) may gather or otherwise obtain data, encrypt the data with a HE process implemented in HE accelerator circuitry, and send the encrypted data to the CSP.

CSP 102 runs application using HE data 104 on one or more servers in a CSP data center(s) to produce HE output data based at least in part on the HE input data received from sources such as secure sensors 1 108 . . . secure sensor N 118. Since the HE input data and the resulting HE output data are encrypted with the HE process, and never decrypted while at the CSP, the CSP cannot access the client device (e.g., sensor) data in cleartext form.

In an implementation, a client device called a secure controller 130 is provided in HE system 100 to allow a user to manage and/or control HE processing by application using HE data 104 in the CSP. In an example, secure controller 130 may be a computing system operated by a user (such as a personal computer, smartphone, tablet computer, etc.) to select and/or send HE encrypted input commands and/or data to application using HE data 104 running in the CSP and receive HE output data from the application using HE data. Secure controller 130 includes processor 132 to run application control program 134 to allow the user to send HE encrypted input data, receive HE output data, and display information to the user. For example, the application control program 134 may display in real-time information from sensors monitoring a power plant. There may be many secure sensors “in the field” and the user of the secure controller may be tasked with managing the sensors remotely. The user cannot physically interact with the secure sensors but can remotely manage them and view results of the data collection by the sensors. The user may securely query the secure data analysis being performed by application using HE data 104 by sending protected commands to the CSP. Secure controller 130 includes HE accelerator circuitry 0 136 to encode, decode, encrypt, and decrypt data according to a HE process. Secure controller 130 includes network interface 138 to send and receive data over network 106 to and from CSP 102.

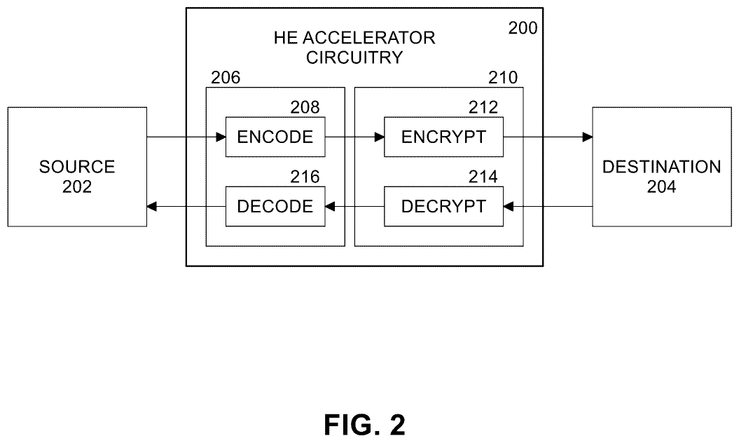

FIG. 2 illustrates HE accelerator circuitry according to an implementation. HE accelerator circuitry 200 represents circuitry implemented as one or more of HE accelerator circuitry 0 136, and HE accelerator circuitry 1 112 . . . HE accelerator circuitry N 122 of FIG. 1. HE accelerator circuitry 200 implements any selected suitable HE process now known or hereafter developed (such as Brakerski, Gentry, Vaikuntanathan (BGV), Cheon, Kim, Kim, Song (CKKS), Fully Homomorphic Encryption, etc.). HE accelerator circuitry 200 include encode/decode circuitry 206 and encrypt/decrypt circuitry 210. Encode/decode circuitry 206 includes encode circuitry 208 to encode cleartext data received from source 202 (for example, a client device such as one of the secure sensors) into plaintext data. In an implementation, encode circuitry 208 accepts as input cleartext data formatted as an array of packed integers or floating-point values whose number of elements is less than a currently configured slot count and outputs a polynomial ring with values encoded according to a current configuration (plaintext data). Encrypt circuitry 212 encrypts plaintext data into HE data according to a HE process. In an implementation, encrypt circuitry 212 accepts as input a polynomial ring vector of plaintext data and outputs a polynomial ring vector of ciphertext data. The HE data may then be sent to destination 204 (for example, application using HE data 104 in CSP 102).

Decrypt circuitry 214 decrypts HE data received from destination 204 (for example, CSP 104) into plaintext data. In an implementation, decrypt circuitry 214 accepts as input a polynomial ring vector of ciphertext data and outputs a polynomial ring vector of plaintext data. Decode circuitry 216 decodes plaintext data into cleartext data. In an implementation, decode circuitry 216 accepts as input a polynomial ring of plaintext data and outputs cleartext data formatted as an array of packed integers or floating-point values whose number of elements is less than a currently configured slot count. Cleartext data may then be sent to source 202 (for example, a component within secure controller 130, such as processor 132). Thus, plaintext data is only handled within HE accelerator circuitry 200 and is not exposed outside of HE accelerator circuitry 200.

In an implementation, source 202 may be secure controller 130 and destination 204 may be CSP 102, when HE data (such as encrypted control commands) is sent from secure controller 130 to the CSP. In an implementation, source 202 may be one of the secure sensors and destination 204 may be the CSP, when HE data (such as encrypted sensor data) is sent to from a secure sensor and to the CSP.

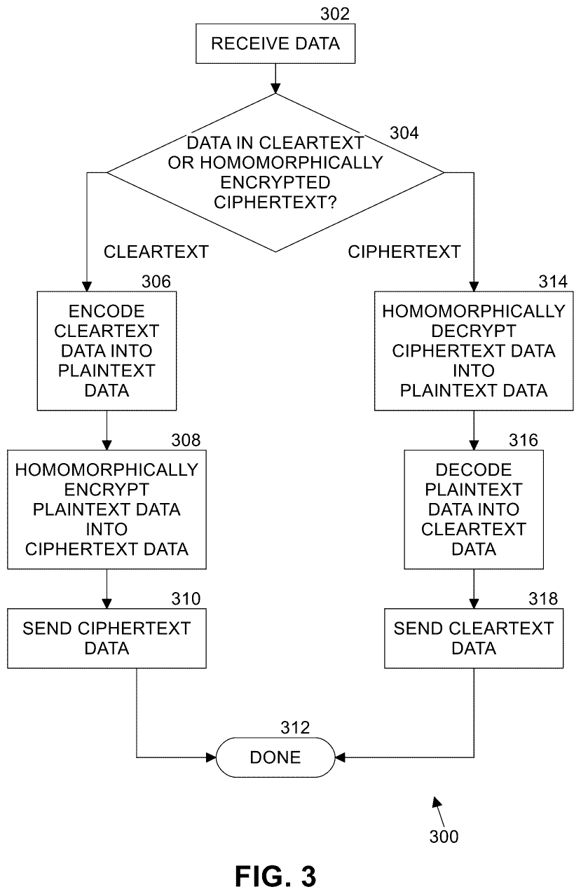

FIG. 3 is a flow diagram of HE accelerator processing 300 according to an implementation. The actions of FIG. 3 may be performed by HE accelerator circuitry 200 of FIG. 2. At block 302, HE accelerator circuitry 200 receives data, which may cleartext data or HE ciphertext data. At block 304, if the received data is cleartext data, then at block 308 HE accelerator circuitry 200 encodes the cleartext data into plaintext data by encode circuitry 208. At block 308, HE accelerator circuitry 200 encrypts the plaintext data using a HE process into ciphertext data (that is, HE data) by encrypt circuitry 212. At block 310, HE accelerator circuitry 200 sends the ciphertext data out of the HE accelerator circuitry for subsequent use in HE system 100 and encryption processing is complete at block 312.

At block 304, if the received data is ciphertext data (that is, HE data), then at block 314 HE accelerator circuitry 200 decrypts the ciphertext data using a HE process into plaintext data by decrypt circuitry 214. At block 316, HE accelerator circuitry 200 decodes the plaintext data into cleartext data by decode circuitry 216. At block 318, HE accelerator circuitry 200 sends the cleartext data out of the HE accelerator circuitry for subsequent use in HE system 100 and decryption processing is complete at block 312.

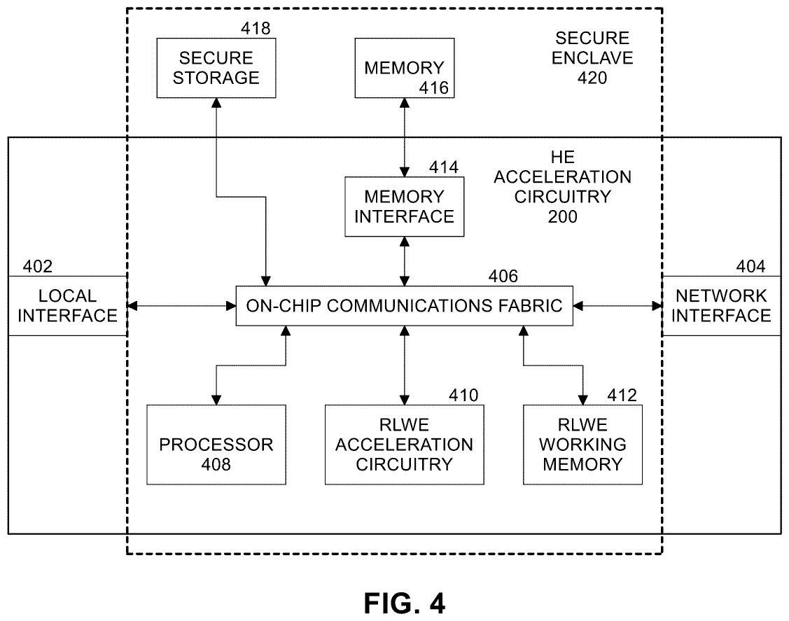

FIG. 4 illustrates HE accelerator circuitry 200 according to an implementation. In one example, HE accelerator circuitry 200 is implemented as an ASIC (e.g., SoC) which may be included in client devices such as secure controller 130 and/or one or more secure sensors 108 . . . 118. Local interface 402 couples HE accelerator circuitry 200 to an application, such as application control program 134 or an application on a client device (such as a secure sensor) communicating with a sensor (or other data gathering component). In an implementation, local interface 402 may be a low-speed point-to-point interface such as peripheral component interconnect express (PCIe), universal serial bus (USB), Ethernet, inter-integrated circuit (I2C), or any other hardware communications interface. Network interface 404 may be a high-speed external interface to network 106 connecting to CSP 102. This may be PCIe, Ethernet, or other hardware communications interface. In an implementation, network interface 404 may not be secure. On-chip communications fabric 406 may be a common communications fabric for moving data between components of HE circuitry 200, such as advanced extensible interface (AXI), Intel® on-chip system fabric (IOSF), advanced microcontroller bus architecture high-performance bus (AHB), or other high-speed internal fabric.

Processor 408 manages data flow, HE workloads and security controls for HE accelerator circuitry 200. In an implementation, processor 408 may be an ARM® core, an Intel® Atom® core, an Altera® Nios® core, or other embedded processor.

Secure storage 418 provides for protected storage of keys and program instructions (e.g., embedded firmware (FW)) for processor 408. Keys and the program instructions must be kept private and may be updated via a secure method, using encrypted and signed files, for example. This data must be kept secure at all costs since a breach could allow an attacker to steal the keys or modify the firmware in a malicious manner. A successful attack may result in the system appearing to work correctly but the keys and data stream are forwarded to another destination. Therefore, secure storage must have severe limitations on its access. This may be done physically by making the keys write only and unobservable outside the SOC (e.g., by using a secure enclave 420). This may be accomplished through the use of encrypted and signed FW distribution methods, for example. The physical storage of secure storage 418 may be an internal static random-access memory (SRAM), an in-package SRAM, an external secure digital (SD) device using encrypted communications, or another device that meets security and privacy requirements.

Memory 416 may be a high-speed memory device implemented by a dynamic random-access memory (DRAM) using a security protocol such as total memory Encryption (TME) or an internal memory implemented as an on-package RAM or on-chip RAM. Memory interface 414 provides communications between on-chip communications fabric 406 and memory 416 for use by processor 408 and for storing queued work and HE results. In an implementation, secure storage 418 and memory 416 may be implemented outside of HE accelerator circuitry 200 but within a secure enclave 420. Secure enclave 420 is a hardware protection feature encompassing all portions of HE accelerator circuitry 200 that must be secured to protect against physical attacks, as well as host-based attacks.

In an implementation, ring learning with errors (RLWE) acceleration circuitry 410 includes hardware acceleration functionality necessary for implementing HE encoding, encrypting, decoding and decrypting functions according to a selected HE process using RLWE. In other implementations, acceleration circuitry 410 may implement a selected HE process other than RLWE. RLWE working memory 412 may be a RAM to store key-value pair information during HE processing by RLWE acceleration circuit 410.

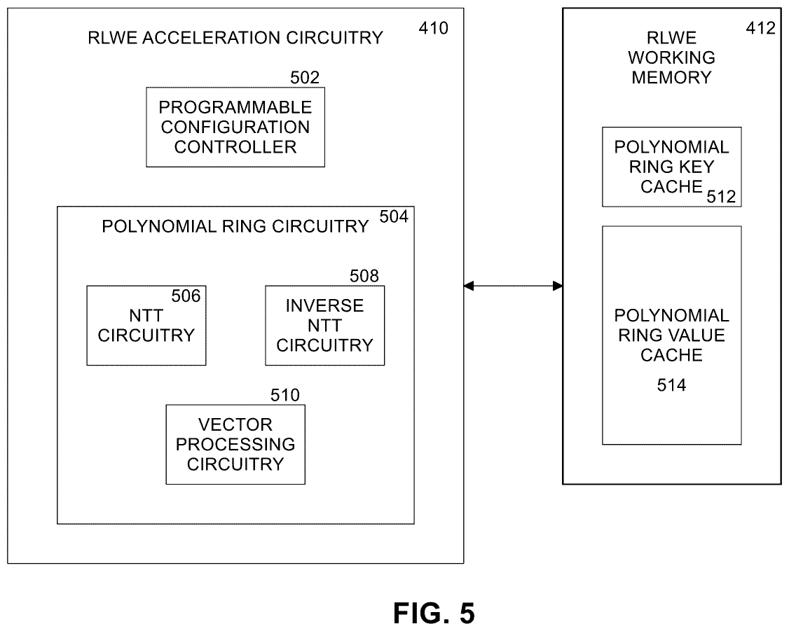

FIG. 5 illustrates RLWE acceleration circuitry 410 and RLWE working memory 412 of HE accelerator circuitry 200 according to an implementation. RLWE acceleration circuitry 410 includes programmable configuration controller 502 to configure HE processing, which includes a plurality of control and status registers for interfacing with polynomial ring circuitry 504. Polynomial ring circuitry 504 comprises circuitry to perform the HE process. Polynomial ring circuitry 504 includes number theoretic transform (NTT) circuitry 506 to perform NTT operations in association with vector processor circuitry 510. In an implementation, NTT circuitry 506 operates on a vector of 64-bit integers. Inverse NTT circuitry 508 performs inverse NTT operations in association with vector processing circuitry 510. In an implementation, NTT circuitry 506 operates on a vector of 64-bit integers. Vector processing circuitry 510 performs accelerated arithmetic operations for HE operations of the HE process, such as NTT, inverse NTT, and other vector operations (e.g., multiply, add, subtract, modulus) required for encoding, encrypting, decoding and decrypting the RLWE-based HE process.

RLWE working memory 412 includes polynomial ring key cache 512 to store local versions of keys required for encrypt and decrypt operations of the HE process performed by RLWE acceleration circuitry 410. In an implementation, public keys are used for encryption and private keys are used for decryption. Polynomial ring value cache 514 stores intermediate values while RLWE acceleration circuitry 410 performs RLWE operations of the HE process.

In an implementation, HE system 100 includes a client device (e.g., secure sensor 108 . . . 118) including a data gathering device (e.g., sensor 1 110 . . . sensor N 120) to gather cleartext data and first homomorphic encryption (HE) acceleration circuitry (HE acceleration circuitry 1 112 . . . HE acceleration circuitry N 124) to encrypt the cleartext data with a HE process into HE ciphertext input data; a server (e.g., CSP 102) to receive the HE ciphertext input data from the client device, process the HR ciphertext input data, and generate HE ciphertext output data, without decrypting the HR ciphertext input data and the HR ciphertext output data; and a controller device (e.g., secure controller 130) including second HE acceleration circuitry (e.g., HE acceleration circuitry 0 136) to receive the HR ciphertext output data from the server and decrypt the HE ciphertext output data into cleartext data.

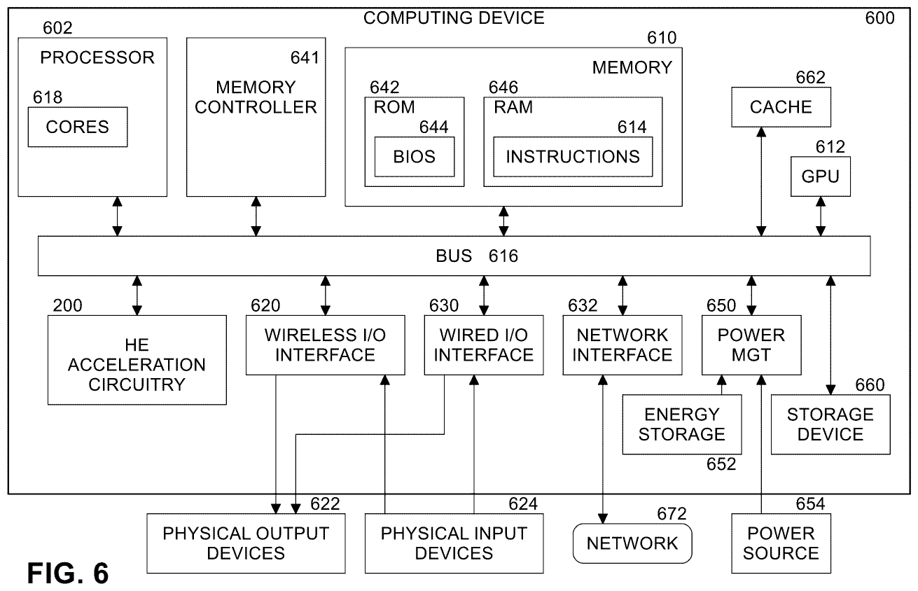

FIG. 6 is a schematic diagram of an illustrative electronic computing device including HE accelerator circuitry 200 to perform HE processing according to an implementation. In an embodiment, computing device 600 is representative of secure controller 130, where processor 602 is an instance of processor 132, homomorphic encryption (HE) accelerator circuitry 200 is an instance of HE accelerator circuitry 0 136, and network interface 632 is an instance of network interface 138. In another implementation, computing device 600 is representative of any one of secure sensors 1 108 . . . N 118 (or other client devices), where HE accelerator circuitry 200 is an instance of any one of HE accelerator circuitry 1 112 . . . N 122, and network interface 632 is an instance of any one of network interface (NW I/F) 1 114 . . . N 124. Some components of computing device 600 may be omitted for performance, power, needed capability and/or cost reasons, and one or more sensors may be added, as needed.

In some embodiments, the computing device 600 includes one or more processors 610 including one or more processors cores 618 and memory controller 641 to perform encode/decode/encrypt/decrypt processing, as described in FIGS. 1-5. In some embodiments, the computing device 600 includes one or more HE accelerator circuitry 200 components.

In some embodiments, the computing device 600 is to implement at least a portion of HE system processing, as described in FIGS. 1-5.

The computing device 600 may additionally include one or more of the following: cache 662, a graphical processing unit (GPU) 612 (which may be the hardware accelerator in some implementations), a wireless input/output (I/O) interface 620, a wired I/O interface 630, memory circuitry 640, power management circuitry 650, non-transitory storage device 660, and a network interface 670 for connection to a network 672. The following discussion provides a brief, general description of the components forming the illustrative computing device 600. Example, non-limiting computing devices 600 may include a desktop computing device, blade server device, workstation, or similar device or system.

In embodiments, the processor cores 618 are capable of executing machine-readable instruction sets 614, reading data and/or instruction sets 614 from one or more storage devices 660 and writing data to the one or more storage devices 660. Those skilled in the relevant art will appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, and the like. For example, machine-readable instruction sets 614 may include instructions to implement HE encoding/decoding/encrypting/decrypting processing, as provided in FIGS. 1-5.

The processor cores 618 may include any number of hardwired or configurable circuits, some or all of which may include programmable and/or configurable combinations of electronic components, semiconductor devices, and/or logic elements that are disposed partially or wholly in a PC, server, or other computing system capable of executing processor-readable instructions.

The computing device 600 includes a bus or similar communications link 616 that communicably couples and facilitates the exchange of information and/or data between various system components including the processor cores 618, the cache 662, the graphics processor circuitry 612, one or more wireless I/O interfaces 620, one or more wired I/O interfaces 630, one or more storage devices 660, and/or one or more network interfaces 670. The computing device 600 may be referred to in the singular herein, but this is not intended to limit the embodiments to a single computing device 600, since in certain embodiments, there may be more than one computing device 600 that incorporates, includes, or contains any number of communicably coupled, collocated, or remote networked circuits or devices.

The processor cores 618 may include any number, type, or combination of currently available or future developed devices capable of executing machine-readable instruction sets.

The processor cores 618 may include (or be coupled to) but are not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 6 are of conventional design. Consequently, such blocks need not be described in further detail herein, as they will be understood by those skilled in the relevant art. The bus 616 that interconnects at least some of the components of the computing device 600 may employ any currently available or future developed serial or parallel bus structures or architectures.

The system memory 640 may include read-only memory (“ROM”) 642 and random-access memory (“RAM”) 646. Memory 640 may be managed by memory controller 641. Data and ECC bits may be written to and read from memory 640 by processor 610 using memory controller 641. A portion of the ROM 642 may be used to store or otherwise retain a basic input/output system (“BIOS”) 644. The BIOS 644 provides basic functionality to the computing device 600, for example by causing the processor cores 618 to load and/or execute one or more machine-readable instruction sets 614. In embodiments, at least some of the one or more machine-readable instruction sets 614 cause at least a portion of the processor cores 618 to provide, create, produce, transition, and/or function as a dedicated, specific, and particular machine, for example a word processing machine, a digital image acquisition machine, a media playing machine, a gaming system, a communications device, a smartphone, a neural network, a machine learning model, or similar devices.

The computing device 600 may include at least one wireless input/output (1/O) interface 620. The at least one wireless I/O interface 620 may be communicably coupled to one or more physical output devices 622 (tactile devices, video displays, audio output devices, hardcopy output devices, etc.). The at least one wireless I/O interface 620 may communicably couple to one or more physical input devices 624 (pointing devices, touchscreens, keyboards, tactile devices, etc.). The at least one wireless I/O interface 620 may include any currently available or future developed wireless I/O interface. Example wireless I/O interfaces include, but are not limited to: Bluetooth®, near field communication (NFC), and similar.

The computing device 600 may include one or more wired input/output (I/O) interfaces 630. The at least one wired I/O interface 630 may be communicably coupled to one or more physical output devices 622 (tactile devices, video displays, audio output devices, hardcopy output devices, etc.). The at least one wired I/O interface 630 may be communicably coupled to one or more physical input devices 624 (pointing devices, touchscreens, keyboards, tactile devices, etc.). The wired I/O interface 630 may include any currently available or future developed I/O interface. Example wired I/O interfaces include but are not limited to universal serial bus (USB), IEEE 1394 (“FireWire”), and similar.

The computing device 600 may include one or more communicably coupled, non-transitory, data storage devices 660. The data storage devices 660 may include one or more hard disk drives (HDDs) and/or one or more solid-state storage devices (SSDs). The one or more data storage devices 660 may include any current or future developed storage appliances, network storage devices, and/or systems. Non-limiting examples of such data storage devices 660 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more data storage devices 660 may include one or more removable storage devices, such as one or more flash drives, flash memories, flash storage units, or similar appliances or devices capable of communicable coupling to and decoupling from the computing device 600.

The one or more data storage devices 660 may include interfaces or controllers (not shown) communicatively coupling the respective storage device or system to the bus 616. The one or more data storage devices 660 may store, retain, or otherwise contain machine-readable instruction sets, data structures, program modules, data stores, databases, logical structures, and/or other data useful to the processor cores 618 and/or graphics processor circuitry 612 and/or one or more applications executed on or by the processor cores 618 and/or graphics processor circuitry 612. In some instances, one or more data storage devices 660 may be communicably coupled to the processor cores 618, for example via the bus 616 or via one or more wired communications interfaces 630 (e.g., Universal Serial Bus or USB); one or more wireless communications interfaces 620 (e.g., Bluetooth®, Near Field Communication or NFC); and/or one or more network interfaces 670 (IEEE 802.3 or Ethernet, IEEE 802.11, or Wi-Fi®, etc.).

Processor-readable instruction sets 614 and other programs, applications, logic sets, and/or modules may be stored in whole or in part in the system memory 640. Such instruction sets 614 may be transferred, in whole or in part, from the one or more data storage devices 660. The instruction sets 614 may be loaded, stored, or otherwise retained in system memory 640, in whole or in part, during execution by the processor cores 618 and/or graphics processor circuitry 612.

The computing device 600 may include power management circuitry 650 that controls one or more operational aspects of the energy storage device 652. In embodiments, the energy storage device 652 may include one or more primary (i.e., non-rechargeable) or secondary (i.e., rechargeable) batteries or similar energy storage devices. In embodiments, the energy storage device 652 may include one or more supercapacitors or ultracapacitors. In embodiments, the power management circuitry 650 may alter, adjust, or control the flow of energy from an external power source 654 to the energy storage device 652 and/or to the computing device 600. The power source 654 may include, but is not limited to, a solar power system, a commercial electric grid, a portable generator, an external energy storage device, or any combination thereof.

For convenience, the processor cores 618, the graphics processor circuitry 612, the wireless I/O interface 620, the wired I/O interface 630, the storage device 660, and the network interface 670 are illustrated as communicatively coupled to each other via the bus 616, thereby providing connectivity between the above-described components. In alternative embodiments, the above-described components may be communicatively coupled in a different manner than illustrated in FIG. 6. For example, one or more of the above-described components may be directly coupled to other components, or may be coupled to each other, via one or more intermediary components (not shown). In another example, one or more of the above-described components may be integrated into the processor cores 618 and/or the graphics processor circuitry 612. In some embodiments, all or a portion of the bus 616 may be omitted and the components are coupled directly to each other using suitable wired or wireless connections.

Flowcharts representative of example hardware logic, machine readable instructions, hardware implemented state machines, and/or any combination thereof for implementing computing device 600, for example, are shown in FIGS. 1-5. The machine-readable instructions may be one or more executable programs or portion(s) of an executable program for execution by a computer processor such as the processor 610 shown in the example computing device 600 discussed above in connection with FIG. 6. The program may be embodied in software stored on a non-transitory computer readable storage medium such as a CD-ROM, a floppy disk, a hard drive, a DVD, a Blu-ray disk, or a memory associated with the processor 610, but the entire program and/or parts thereof could alternatively be executed by a device other than the processor 610 and/or embodied in firmware or dedicated hardware. Further, although the example program is described with reference to the flowchart illustrated in FIGS. 1-5, many other methods of implementing the example systems 600 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, IP block, a comparator, an operational-amplifier (op-amp), a logic circuit, etc.) structured to perform the corresponding operation without executing software or firmware.

The machine-readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine-readable instructions may be fragmented and stored on one or more storage devices and/or computing devices (e.g., servers). The machine-readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine-readable instructions may be stored in multiple parts, which are individually compressed, encrypted, and stored on separate computing devices, wherein the parts when decrypted, decompressed, and combined form a set of executable instructions that implement a program such as that described herein.

In another example, the machine-readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine-readable instructions may be configured (e.g., settings stored, data input, network addresses recorded, etc.) before the machine-readable instructions and/or the corresponding program(s) can be executed in whole or in part. Thus, the disclosed machine-readable instructions and/or corresponding program(s) are intended to encompass such machine readable instructions and/or program(s) regardless of the particular format or state of the machine readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C #, Perl, Python, JavaScript, HyperText Markup Language (HTML), Structured Query Language (SQL), Swift, etc.

As mentioned above, the example process of FIGS. 1-6 may be implemented using executable instructions (e.g., computer and/or machine-readable instructions) stored on a non-transitory computer and/or machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended.

The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### Examples

Example 1 is an apparatus including encode circuitry to encode cleartext data into plaintext data; encrypt circuitry to encrypt the plaintext data into homomorphically encrypted (HE) ciphertext data according to an HE process; decrypt circuitry to decrypt the HE ciphertext data into the plaintext data according to the HE process; and decode circuitry to decode the plaintext data into the cleartext data. In Example 2, the subject matter of Example 1 may optionally include wherein the HE process comprises a ring learning with errors (RLWE) process. In Example 3, the subject matter of Example 1 may optionally include the wherein the apparatus comprises accelerator circuitry including the encode circuitry, the decode circuitry, the encrypt circuitry, and the decrypt circuitry as an intellectual property (IP) block of a system on a chip (SoC). In Example 4, the subject matter of Example 1 may optionally include the wherein the accelerator circuitry comprises RLWE acceleration circuitry to perform the HE process. In Example 5, the subject matter of Example 4 may optionally include wherein the RLWE acceleration circuitry comprises a programmable configuration controller circuitry to configure the HE process and polynomial ring circuitry to perform the HE process.

In Example 6, the subject matter of Example 5 may optionally include wherein the polynomial ring circuitry comprises number theoretic transform (NTT) circuitry to perform NTT operations of the HE process, inverse NTT circuitry to perform inverse NTT operations of the HE process, and vector processing circuitry to perform accelerated arithmetic operations of the HE process. In Example 7, the subject matter of Example 4 may optionally include wherein the accelerator circuitry comprises a RLWE working memory to store key-value pair information of the HE process. In Example 8, the subject matter of Example 7 may optionally include wherein the RLWE working memory comprises a polynomial ring key cache to store local versions of keys used by the encrypt circuitry and the decrypt circuitry to perform the HE process and a polynomial ring value cache to store intermediate data values generated during performance of the HE process by the RLWE acceleration circuitry.

Example 9 is a method including receiving data in a homomorphically encrypted (HE) accelerator circuitry; determining, by the HE accelerator circuitry, if the data is cleartext data or HE ciphertext data encrypted by a HE process; in response to determining that the data is cleartext data, encoding, by the HE accelerator circuitry, the cleartext data into plaintext data and encrypting the plaintext data into HE ciphertext data according to the HE process; and in response to determining that the data is HE ciphertext data, decrypting, by the HE accelerator circuitry, the HE ciphertext data into plaintext data according to the HE process and decoding the plaintext data into cleartext data. In Example 10, the subject matter of Example 9 may optionally include wherein the HE process comprises a ring learning with errors (RLWE) process. In Example 11, the subject matter of Example 9 may optionally include wherein the HE accelerator circuitry performs the encoding, decoding, encrypting, and the decrypting by an intellectual property (IP) block of a system on a chip (SoC).

In Example 11, the subject matter of Example 9 may optionally include wherein in response to determining that the data is cleartext data, sending the HE ciphertext data from the HE accelerator circuitry after the encoding and the encrypting; and in response to determining that the data is HE ciphertext data, sending the cleartext data from the HE accelerator circuitry after the decrypting and the decoding.

Example 12 is a system including a client device including a data gathering device to gather cleartext data and first homomorphic encryption (HE) acceleration circuitry to encrypt the cleartext data with a HE process into HE ciphertext input data; a server to receive the HE ciphertext input data from the client device, process the HE ciphertext input data, and generate HE ciphertext output data, without decrypting the HE ciphertext input data and the HE ciphertext output data; and a controller device including second HE acceleration circuitry to receive the HE ciphertext output data from the server and decrypt the HE ciphertext output data into cleartext data. In Example 13, the subject matter of Example 12 may optionally include wherein the first HE accelerator circuitry and the second HE accelerator circuitry include encode circuitry to encode the cleartext data into plaintext data; encrypt circuitry to encrypt the plaintext data into the HE ciphertext input data; decrypt circuitry to decrypt the HE ciphertext output data into the plaintext data; and decode circuitry to decode the plaintext data into the cleartext data.

In Example 14, the subject matter of Example 12 may optionally include wherein the client device comprises the encode circuitry, the decode circuitry, the encrypt circuitry, and the decrypt circuitry as an intellectual property (IP) block of a system on a chip (SoC) in the client device. In Example 15, the subject matter of Example 12 may optionally include wherein the controller device comprises the encode circuitry, the decode circuitry, the encrypt circuitry, and the decrypt circuitry as an intellectual property (IP) block of a system on a chip (SoC) in the client device. In Example 16, the subject matter of Example 12 may optionally include wherein the HE process comprises a ring learning with errors (RLWE) process. In Example 17, the subject matter of Example 12 may optionally include wherein the accelerator circuitry comprises RLWE acceleration circuitry to perform the HE process. In Example 18, the subject matter of Example 17 may optionally include wherein the RLWE acceleration circuitry comprises a programmable configuration controller circuitry to configure the HE process and polynomial ring circuitry to perform the HE process. In Example 19, the subject matter of Example 18 may optionally include wherein the polynomial ring circuitry comprises number theoretic transform (NTT) circuitry to perform NTT operations of the HE process, inverse NTT circuitry to perform inverse NTT operations of the HE process, and vector processing circuitry to perform accelerated arithmetic operations of the HE process. In Example 20, the subject matter of Example 12 may optionally include wherein the data gathering device comprises a sensor.

Example 21 is an apparatus operative to perform the method of any one of Examples 9 to 12. Example 22 is an apparatus that includes means for performing the method of any one of Examples 9 to 12. Example 23 is an apparatus that includes any combination of modules and/or units and/or logic and/or circuitry and/or means operative to perform the method of any one of Examples 9 to 12. Example 24 is an optionally non-transitory and/or tangible machine-readable medium, which optionally stores or otherwise provides instructions that if and/or when executed by a computer system or other machine are operative to cause the machine to perform the method of any one of Examples 9 to 12.

The foregoing description and drawings are to be regarded in an illustrative rather than a restrictive sense. Persons skilled in the art will understand that various modifications and changes may be made to the embodiments described herein without departing from the broader spirit and scope of the features set forth in the appended claims.

What is claimed is:

1. An apparatus comprising:
encode circuitry to encode cleartext data into plaintext data;
encrypt circuitry to encrypt the plaintext data into homomorphically encrypted (HE) ciphertext data according to an HE process;
decrypt circuitry to decrypt the HE ciphertext data into the plaintext data according to the HE process; and
decode circuitry to decode the plaintext data into the cleartext data.

2. The apparatus of claim 1, wherein the HE process comprises a ring learning with errors (RLWE) process.

3. The apparatus of claim 1, wherein the apparatus comprises accelerator circuitry including the encode circuitry, the decode circuitry, the encrypt circuitry, and the decrypt circuitry as an intellectual property (IP) block of a system on a chip (SoC).

4. The apparatus of claim 3, wherein the accelerator circuitry comprises RLWE acceleration circuitry to perform the HE process.

5. The apparatus of claim 4, wherein the RLWE acceleration circuitry comprises a programmable configuration controller circuitry to configure the HE process and polynomial ring circuitry to perform the HE process.

6. The apparatus of claim 5, wherein the polynomial ring circuitry comprises number theoretic transform (NTT) circuitry to perform NTT operations of the HE process, inverse NTT circuitry to perform inverse NTT operations of the HE process, and vector processing circuitry to perform accelerated arithmetic operations of the HE process.

7. The apparatus of claim 4, wherein the accelerator circuitry comprises a RLWE working memory to store key-value pair information of the HE process.

8. The apparatus of claim 7, wherein the RLWE working memory comprises a polynomial ring key cache to store local versions of keys used by the encrypt circuitry and the decrypt circuitry to perform the HE process and a polynomial ring value cache to store intermediate data values generated during performance of the HE process by the RLWE acceleration circuitry.

9. A method comprising:
receiving data in a homomorphically encrypted (HE) accelerator circuitry;
determining, by the HE accelerator circuitry, if the data is cleartext data or HE ciphertext data encrypted by a HE process;
in response to determining that the data is cleartext data, encoding, by the HE accelerator circuitry, the cleartext data into plaintext data and encrypting the plaintext data into HE ciphertext data according to the HE process; and
in response to determining that the data is HE ciphertext data, decrypting, by the HE accelerator circuitry, the HE ciphertext data into plaintext data according to the HE process and decoding the plaintext data into cleartext data.

10. The method of claim 9, wherein the HE process comprises a ring learning with errors (RLWE) process.

11. The method of claim 9, wherein the HE accelerator circuitry performs the encoding, decoding, encrypting, and the decrypting by an intellectual property (IP) block of a system on a chip (SoC).

12. The method of claim 9, comprising:
in response to determining that the data is cleartext data, sending the HE ciphertext data from the HE accelerator circuitry after the encoding and the encrypting; and
in response to determining that the data is HE ciphertext data, sending the cleartext data from the HE accelerator circuitry after the decrypting and the decoding.

13. A system comprising:
a client device including a data gathering device to gather cleartext data and first homomorphic encryption (HE) acceleration circuitry to encrypt the cleartext data with a HE process into HE ciphertext input data;
a server to receive the HE ciphertext input data from the client device, process the HE ciphertext input data, and generate HE ciphertext output data, without decrypting the HE ciphertext input data and the HE ciphertext output data; and
a controller device including second HE acceleration circuitry to receive the HE ciphertext output data from the server and decrypt the HE ciphertext output data into cleartext data.

14. The system of claim 13, wherein the first HE accelerator circuitry and the second HE accelerator circuitry comprise:
encode circuitry to encode the cleartext data into plaintext data;
encrypt circuitry to encrypt the plaintext data into the HE ciphertext input data;
decrypt circuitry to decrypt the HE ciphertext output data into the plaintext data; and
decode circuitry to decode the plaintext data into the cleartext data.

15. The system of claim 14, wherein the client device comprises the encode circuitry, the decode circuitry, the encrypt circuitry, and the decrypt circuitry as an intellectual property (IP) block of a system on a chip (SoC) in the client device.

16. The system of claim 14, wherein the controller device comprises the encode circuitry, the decode circuitry, the encrypt circuitry, and the decrypt circuitry as an intellectual property (IP) block of a system on a chip (SoC) in the client device.

17. The system of claim 13, wherein the HE process comprises a ring learning with errors (RLWE) process.

18. The system of claim 17, wherein the accelerator circuitry comprises RLWE acceleration circuitry to perform the HE process.

19. The system of claim 18, wherein the RLWE acceleration circuitry comprises a programmable configuration controller circuitry to configure the HE process and polynomial ring circuitry to perform the HE process.

20. The system of claim 19, wherein the polynomial ring circuitry comprises number theoretic transform (NTT) circuitry to perform NTT operations of the HE process, inverse NTT circuitry to perform inverse NTT operations of the HE process, and vector processing circuitry to perform accelerated arithmetic operations of the HE process.

21. The system of claim 13, wherein the data gathering device comprises a sensor.
